(19) United States
(12) Patent Application Publication
(10) Pub. No.: US 2015/0190916 A1
(43) Pub. Date: Jul. 9, 2015

(54) Portable winch driver

(71) Applicant: James S. Bergman, Cambridge, MN (US)

(72) Inventor: James S. Bergman, Cambridge, MN (US)

(21) Appl. No.: 14/593,463

(22) Filed: Jan. 9, 2015

Related U.S. Application Data
(60) Provisional application No. 61/925,482, filed on Jan. 9, 2014.

(51) Int. Cl. B25F 3/00; B66D 1/14

(52) U.S. Cl. CPC B25F 3/00; B66D 1/14

(57) ABSTRACT

A method and device for automatically raising and lowering a large and/or heavy object, for example an icehouse, comprising a body having a first cylindrical end configured for insertion into a chuck of a portable drill and a second opposing body end configured for connection with a winch shaft wherein activating the portable drill will rotate the first and second ends and thus rotate the winch shaft to raise or lower an icehouse. The second end is adapted with a substantially flat outer facing surface having an integral cavity therein. The cavity is machined for engagement with the winch shaft and to efficiently transfer torque from the drill to the winch device for winding up or letting out a winch cable and thus raising or lower a large object connected to the winch system.

### BACKGROUND

Manual crank hand winches are commonly used in a variety of lift systems. A winch system generally includes a handle, which an operator will turn or rotate around a spool to wind up or let out a cable. To provide a user with enough leverage to wind up or let out a winch system such that a larger object can be raised or lowered, these hand winches are generally adapted with a large wheel instead of a handle.

A wire rope or cable is generally wound around a spool or winch drum such that the wire rope or cable can be wound up or let out to raise or lower an object. To make a winch system that is faster and easier to use to raise or lower a large or heavy object, winches may replace the handle or wheel with a gear assembly powered by an electric, hydraulic, pneumatic or internal combustion drive. These drive systems are expensive and cumbersome and are not portable.

A problem arises when a large or heavy object must be raised or lowered and a user would be fatigued quickly by cranking a handle to move the heavy object. In these situations a wheel may not sufficiently overcome the leverage problem, or may simply be too big or unable to fit in the space where the winch is used.

### SUMMARY OF INVENTION

An aspect of the present disclosure relates to a device for automatically raising and lowering a large and/or heavy object, for example an icehouse comprising a body having a first cylindrical end configured for insertion into a chuck of a portable drill and a second opposing body end configured for connection with a winch shaft wherein activating the portable drill will rotate the first and second ends and thus rotate the winch shaft to raise or lower an icehouse. The second end is adapted with a substantially flat outer facing surface having an integral cavity therein. The cavity is machined for engagement with the winch shaft and to efficiently transfer torque from the drill to the winch device for winding up or letting out a winch cable and thus raising or lower a large object connected to the winch system.

Another aspect of the present disclosure relates to a method of engaging a winch and automatically rotating a winch spool to wind up and/or let out a winch cable. The method comprises inserting a tool into a chuck of a portable drill; removing a winch handle and winch to expose a winch shaft and engaging an opposing end of the tool with the winch shaft. By removing a winch spool locking mechanism and activating the portable drill to rotate the tool, winch shaft will also rotate and cause the winch spool to wind up the cable. Reversing the drill direction and rotating the winch spool in an opposite direction can also let out the cable.

Yet another aspect of the present disclosure also relates to a method of raising or lowering a boat or an icehouse, either object supported by a lift or winch system, by automatically winding the winch. The method of winding the winch comprises inserting a first end of a tool into a chuck of a portable drill; removing a winch handle and winch nut and exposing a winch shaft; placing a second end of the tool, the second end having a cavity, onto the winch shaft and engaging the cavity with the winch shaft. The method further comprises removing a winch spool locking mechanism and activating the portable drill to rotate the first and second ends of the tool wherein rotating the tool causes the cavity to rotate against the winch shaft causing the winch shaft to rotate and the winch spool to rotate to either wind up or let out the cable.

### DESCRIPTION OF THE DRAWINGS

FIG. 1 is a side perspective view of the tool of the present invention.

FIG. 2 is a bottom perspective view of the present invention.

FIG. 3 is a side perspective view of the tool of the present invention.

FIG. 4 is a cross-sectional and alternative view of the tool of the present invention.

FIG. 5 is a front view of the tool of the present invention.

FIG. 6 is an illustration of the tool engaged with a winch shaft.

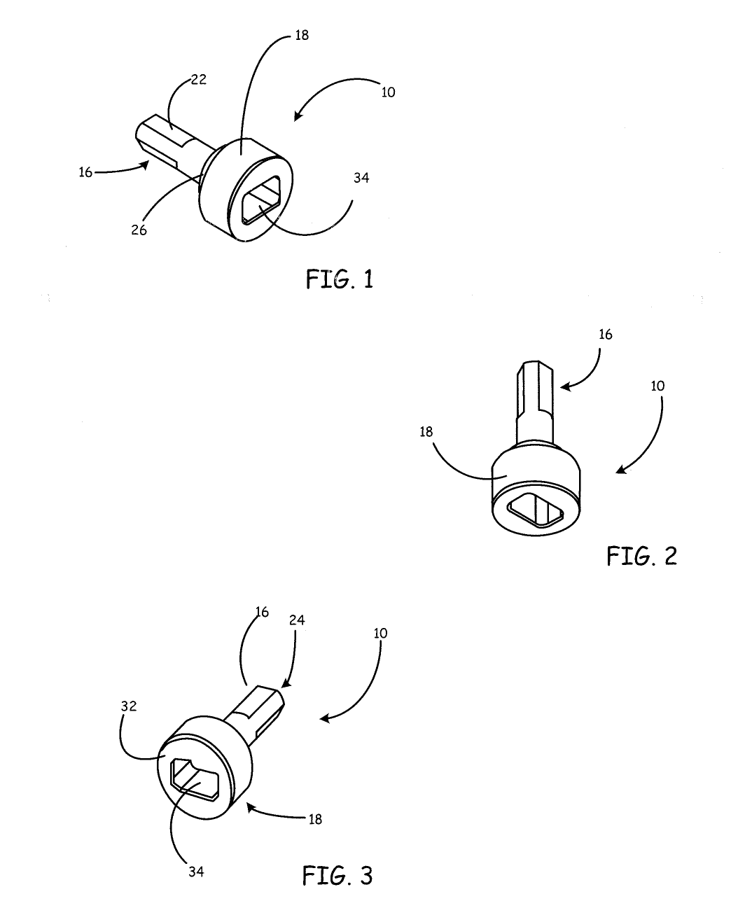

### DETAILED DESCRIPTION

In moving large and/or heavy objects including lifting or lowering a boat out of or into a body of water or raising and/or lowering an ice-house out on a lake, it may not always be practical for a user to utilize a standard winch handle. Additionally, it may not be practical to add a wheel to the winch to wind up or let out the cable. It can also be expensive to incorporate an electric, pneumatic or hydraulic powered gear system to drive the winch system. In other instances, space constraints or the location of the winch lift system and object to be moved may prevent the winding of the winch by any means other than manual.

The tool of the present disclosure can be used with most standard winch systems. The winches may be part of lift systems for a boat or an icehouse. It should be understood that the of the present invention is very versatile and can be used in a wide range of situations which may not be mentioned herein. Wherever a winch is used to lift an object, the tool of this invention will prove useful. For example, the tool may be used to raise or lower a variety of heavy and/or large objects including any kind of boat and boat lift. The tool may also be used with a trailer, or with any towing system for watercraft or snow-craft as well as for lifting and lowering ice houses. tool can be used in a shop where large objects, such as engines, need to be lifted and lowered. use of a portable or hand-held drill enables the tool to be used with winch devices across a of uses.

The present disclosure, as illustrated generally in the Figures, relates to a tool 10 for a hand-held or portable drill 12 and a method of using the drill and tool to automatically wind up or let out a cable using a winch system 14. The tool 10 is configured for connection with a chuck of a portable or handheld drill and also to engage with a rotatable drive shaft of a winch, usually via connection directly to the terminal end of the winch shaft 36. The tool 10 is a machined blocked of steel, stainless or otherwise, the tool having an overall length greater than its width. The tool may alternatively be machined from other suitable metals or metal alloys, including but not limited to aluminum. The tool comprises a chuck engaging end 16 and a body 18. The chuck engaging 16 end is adapted along its length for securely engaging with the chuck of a portable or hand held drill.

The chuck engaging end of the tool is connectable with the drill by insertion of the chuck engaging end into any standard drill chuck and clamping, tightening or securing the chuck around the chuck engaging end. The chuck engaging end 16 is in the form of a generally cylindrical exterior 20. The cylindrical exterior has been machined along a portion of its length such that a cross-sectional shape of the distal end of the tube is no longer circular, but instead comprises flat sections interrupting the circumference of the cross-section. The cylindrical exterior is machined with at least one and preferably three flat sections 22, which are positioned around the distal end 24 of the cylinder 20. The flat sections 22 are positioned opposing one another and extend approximately half way along the length of the cylindrical exterior 20, from the distal end and terminating near the center of the length. The distal length 24 of the cylindrical exterior is thus adapted for secure connection and frictional engagement with the chuck. Once inserted into the chuck of the portable or hand-held drill, rotation of the chuck will in turn rotate

The cylindrical exterior section 20 is integrally formed with the body 18 such that the 18 is positioned opposite the chuck engaging end 16. An integral arcuate riser 26 is formed at junction of the tube and the body. The body 18 of the tool is a solid cylinder comprising stainless steel and having a circumference 28 greater than the chuck engaging end and having a length 30 less than the chuck engaging end 16. The body 18 also has a substantially smooth and flat outwardly facing surface 32. The body 18 may be substantially cylindrical in shape or may have elliptical, rectangular, pentagonal or other shaped circumference. The outwardly facing surface is adapted with a cavity 34, the cavity 34 approximately centered in the surface 32. The cavity 34 of a shape substantially machined to mate with a winch shaft 36 of a winch system used to raise lower boats, water craft and/or ice houses or any other object as previously discussed.

The winch shaft 36 of the rotatable drive shaft has an end for engaging with a winch handle or lever and is secured thereto by a nut. This end of the winch shaft 36 is generally substantially rectangular in shape. The winch shaft 36 is rotatable about an axis along its length and is integral to driving the winch system and rotating the winch spool. Winch systems are usually obtained with a factory provided winch handle, wheel or other rotatable lever secured to the winch shaft 36 with a winch nut in order to facilitate winding of the winch spool. Other winch systems may use other methods of retention such as slides or other devices that do require a threaded attachment mechanism, all such mechanisms are contemplated herein. Displacement of the handle, lever or wheel thus acts to rotate the winch shaft 36, which rotates a spool in a direction for winding up or letting out the winch cable.

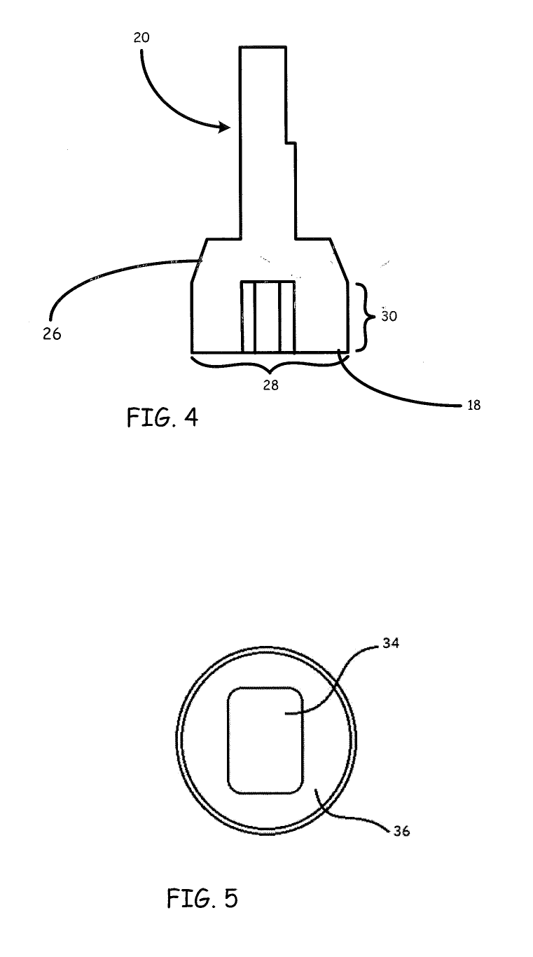

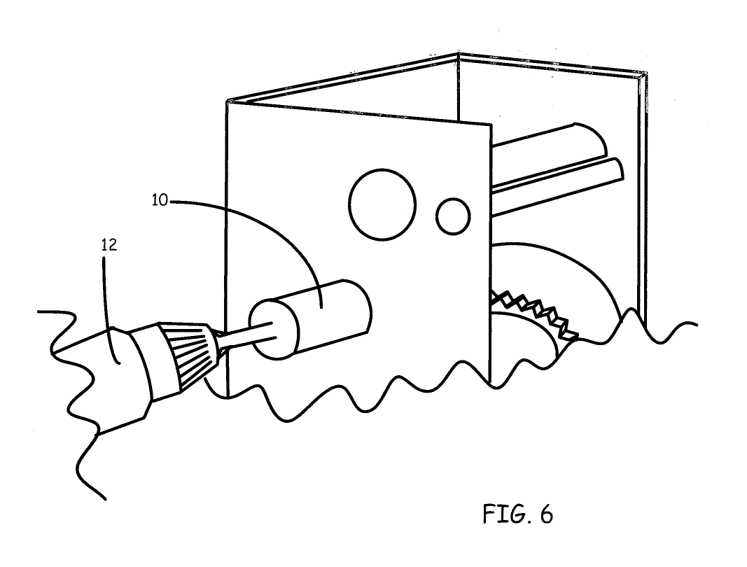

The cavity 34 thus is configured to engage with the end of the winch shaft 36 of the rotatable drive of the winch system. The cavity 34 is of a depth approximately equal to the outwardly extending end of the winch shaft 36, the end previously engaged with the handle, lever or wheel. In the embodiment illustrated in FIGS. 4 and 5, the cavity 34 is substantially rectangular in shape having a width approximately 0.75 inches, a height approximately 0.5 inches and a depth of approximately 0.625 inches. The actual dimensions and shape of the cavity may vary depending on the rotatable drive shaft 36 of the winch system and the size and/or shape of the winch shaft 36 of the system.

When engaged, the winch shaft 36 will fit snugly within the cavity 34 such that a back of the cavity abuts an outward face or terminal end of the winch shaft 36 while each side of the cavity abuts a side of the winch shaft 36 respectively. The cavity is of a depth sufficient to with the end of the winch shaft 36 and to effectively provide torque transfer to the winch shaft 36 to safely and easily rotate the shaft 36 without the tool slipping out of engagement with the shaft during rotation. The cavity depth also considers the distance available on the winch shaft 36 such that connection with the tool does not interfere with the drive shaft component rotation. When tool is secured to the outwardly extending end of the winch shaft 36, the shaft is rotatable to windup or let out the cable by rotating the winch spool wherein the winch shaft 36 is rotated by rotation of the body 18. Rotation of the body 18 thus rotates the side walls of the cavity 34, transfers the rotational torque to and will rotationally displace the winch shaft 36, turning and/or rotating the winch shaft 36 accordingly. The direction of rotation of the tool and the winch shaft is determined by the selected direction of operation of the portable or handheld drill.

A method of using a lift to raise or lower an object, the lift utilizing a winch system, includes the tool selectively attached and secured to the chuck of the portable or hand-held power drill. The tool may be temporarily attached so that the power drill may also be used with various drill bits when not raising or lowering a lift. Alternatively, the tool can be permanently secured to the chuck of the portable drill. When the tool 10 is secured, whether permanently or temporarily, to the chuck the power drill 12 will rotate the tool 10 in the direction of the drill. The tool 10 can be rotated in the forward and reverse directions in accordance with the operation

A method of raising and/or lowering the object utilizing the winch system includes first attaching the first end of the tool to the chuck. This is generally done by inserting the first end 16 into the chuck opening, and tightening the chuck with respect to holding the first end 16 of the tool 10 therein. The user then simply removes the winch handle and winch nut, or other means securing the handle; lever or wheel to the winch drive system, to expose the winch shaft 36. The body 18 of the tool 10 is then engaged with the winch shaft 36 such that the winch shaft 36 is inserted into the cavity 34 and the tool 10 and power drill assembly 12 temporarily replaces the winch handle. A spring-loaded pawl engages the dogs (teeth) on a ratchet wheel of the winch and so the pawl must be disengaged. The power drill is then set for direction of movement such that the drill direction is reversed to wind up the cable and thus raise the object or is alternatively set in the forward direction to let out the cable and thus lower the object.

Although the present invention has been described with reference to preferred embodiments, workers skilled in the art will recognize that changes may be made in form and detail without departing from the spirit and scope of the invention.

What is claimed is:

1. A method of automatically winding up a cable of a winch system, the method comprising:
inserting a device having an end engageable by a chuck of portable drill into the chuck of a portable drill;
removing a winch handle to expose a winch shaft;
engaging an opposing end of the device, which has a cavity configured to engage the winch shaft, with the winch shaft;
disengaging a winch spool locking mechanism; and
activating the portable drill to rotate the device, which in turn rotates the winch shaft and causes the winch spool to wind up the cable.

2. The method of claim 1 and further comprising reversing the portable drill direction and engaging the device with the winch shaft to rotate the winch spool and let out the cable.

3. The method of claim 1 wherein the device is formed by machining a block of metal to a selected design.

4. The method of claim 3 and further comprising the step of machining the block to form the cavity in the opposing end of the device such that the cavity is machined for engagement with the winch shaft.

5. A device for automatically raising and lowering an icehouse comprising:
a body having a first end configured for insertion into a chuck of a portable drill and a second opposing end configured for connection with a winch shaft wherein activating the portable drill will rotate the first and second ends and thus rotate the winch shaft to raise or lower an icehouse.

6. The device of claim 5 and the body further being comprised of block of metal.

7. The device of claim 5 wherein the metal is one of steel or aluminum.

8. The device of claim 5 wherein the device further comprises a generally cylindrical first end section configured for engagement with the chuck.

9. The device of claim 8 wherein the cylindrical first end comprises at least one flat length extending along at least one side length of the cylindrical section for securing the first end when inserted into the chuck.

10. The device of claim 8 and further comprising an arcuate riser integrally connecting the cylindrical chuck engaging first end to the second end of the body configured for connection with the winch shaft.

11. The device of claim 10 wherein the second end of the device is greater in width than the first end and wherein the first end is greater in length than the second end.

12. The device of claim 5 wherein the cylindrical section and the body are integrally formed and wherein the device comprises an overall length greater than its overall width.

13. The device of claim 5 wherein the second end of the body further comprises a substantially flat outer facing surface configured with a cavity for engagement with the winch shaft.

14. The device of claim 13 wherein the cavity is approximately centered in the outer facing surface.

15. The device of claim 13 wherein the cavity is substantially rectangular in shape and having a width at least approximately 0.75 inches and a height at least approximately 0.5 inches and a depth at least approximately 0.625 inches.

16. A method of raising and lowering an ice house by automatically winding a lift winch spool, the method comprising:
inserting a first end of a device into a chuck of a portable drill;
removing a winch handle and exposing a winch shaft;
inserting the winch nut into a cavity of a second end of the device;
engaging the cavity with the winch shaft;
disengaging a winch spool locking mechanism; and
activating the portable drill to rotate the first and second ends of the device wherein rotating the device causes the cavity to rotate against the winch shaft, in turn rotating the winch shaft and causing the winch spool to rotate.

17. The method of claim 16 and further comprising rotating the device in a first direction to wind the cable for raising the icehouse.

18. The method of claim 16 and further comprising rotating the device in a second, opposing direction to let out the cable for lowering the icehouse.

19. The method of claim 16 wherein the device is formed by machining a block of metal to comprise the first and second ends of the device.

20. The method of claim 16 and further comprising the step of machining the block to form the cavity in the opposing end of the device such that the cavity is machined for engagement with the winch shaft.
